(19) United States
(12) Patent Application Publication
(10) Pub. No.: US 2017/0223892 A1
(43) Pub. Date: Aug. 10, 2017

(54) LAWNMOWER WITH FLEXIBLE CUTTER DECK ASSEMBLY

(71) Applicant: Steven A. Snapp, Cynthiana, KY (US)

(72) Inventor: Steven A. Snapp, Cynthiana, KY (US)

(21) Appl. No.: 15/016,331

(22) Filed: Feb. 5, 2016

(51) Int. Cl. A01D 34/81; A01D 34/74

(52) U.S. Cl. CPC A01D 34/81; A01D 34/74; A01D 2101/00

(57) ABSTRACT

A self-propelled mower includes a frame and a mower deck attached to the frame. The mower deck is mounted to the frame in a manner that allows vertical movement and is further mounted to the frame by one or more flexible brackets that allow limited lateral movement of the mower deck relative to the frame of the mower but prevents rearward movement relative to the frame. This allows the mower deck to move relative to the frame when it strikes an object, but stabilizes the mower deck under normal use conditions.

### FIELD OF THE INVENTION

The invention relates to lawnmowers and to the assembly used to attach the mower deck to the frame of the mower.

### BACKGROUND OF THE INVENTION

Riding lawnmowers as well as larger walk-behind lawnmowers include a mower deck which is supported by a frame. The mower deck includes one or more cutting blades. The mower deck is generally suspended from the frame of a lawnmower by some type of connection which permits vertical movement of the mower deck relative to the frame. Typically, chains or straps or the like are used. These allow the mower deck to raise and lower relative to the frame to pass over obstructions and uneven terrain without scalping the grass.

These flexible supports by themselves would allow the deck to move in almost any direction. This amount of movement is unacceptable, as it would interfere with the drive from the motor or engine to the pulleys which drive the cutting blades.

To provide the necessary added support and prevent the swaying, locators are provided that link the mower deck to the frame and allow the deck to move vertically relative to the frame, while inhibiting lateral forward or rearward movement of the deck relative to the frame. These locators are typically inflexible. When the deck strikes an object, the deck absorbs the full impact. Therefore, the deck must be strong enough to withstand the force of the impact. To compensate for this, the mower decks are generally made from a relatively thick gauge metal. This adds weight and requires additional support, which increases costs and reduces mobility. If the force of an impact is too great, the locators can be bent or broken.

### SUMMARY OF THE INVENTION

The present invention provides a self-propelled mower which includes a frame supported on wheels and having a mower deck beneath the frame. The mower deck is fixed to the frame in a manner which permits vertical movement relative to the frame. Further, the deck is attached to the frame by one or more brackets or locators which are flexible and allow for limited lateral movement of the mower deck.

In particular, the flexible brackets include front and rear rigid connectors held together by a flexible member, such as a rubber block or series of rubber pads. The flexible member allows the front and rear rigid connectors to move relative to each other, thus permitting the mower deck to move laterally but with limited range. However, the brackets do not allow the deck to move forwardly or rearwardly relative to the frame. In particular, the brackets can include front and rear clevises connected by a plurality of rubber pads. The front and rear clevises are fixed to the frame and the mower deck respectively by rigid plates, which are pivotally connected to the frame and to the mower deck, which allows for vertical movement.

Thus, a mower having a mower deck attached to the frame in this manner is less prone to damage because the mower deck, when striking an object, can move laterally a limited distance, thus keeping the deck from absorbing the entire impact caused by striking the object. At the same time, the flexible brackets do not allow unlimited movement of the mower deck, providing stability and allowing for proper connection of the mower deck to the motor or engine.

Due to the reduced weight, the mower of the present invention can further be supported on three wheels, as opposed to the typical four wheels, which improves mobility, allowing one to access areas around obstacles more closely with the mower deck.

The objects and advantages of the present invention will be further appreciated in light of the following detailed descriptions and drawings in which:

### BRIEF DESCRIPTION OF THE DRAWINGS

FIG. 1 is a perspective view of a mower according to the present invention with several common components removed;

FIG. 1A is a perspective view of a mower deck support system;

FIG. 2 is a side view of the mower of FIG. 1;

FIG. 3 is an overhead view of the mower of FIG. 1;

FIG. 4 is a perspective view of a connecting bracket;

FIG. 5 is an overhead view of the bracket shown in FIG. 4; and

FIG. 6 is a side view of the bracket shown in FIG. 4.

### DETAILED DESCRIPTION OF THE INVENTION

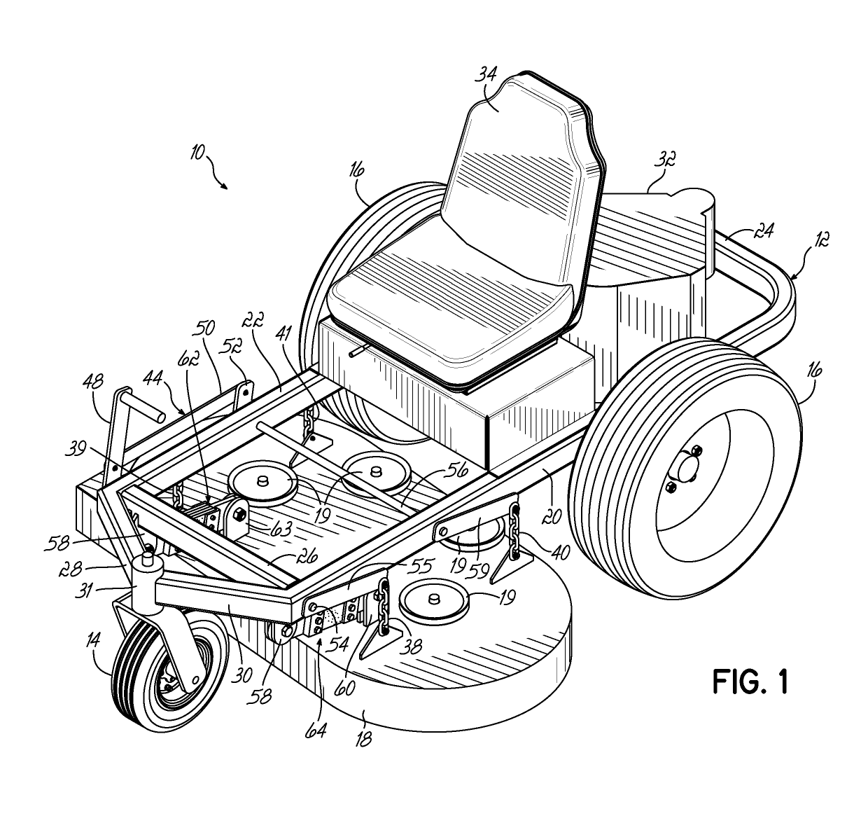

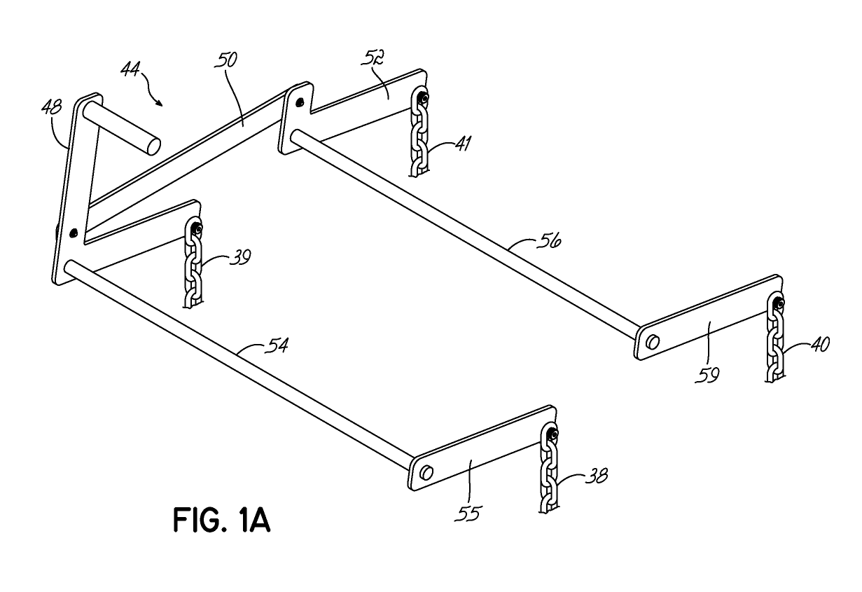

As shown in FIG. 1, the present invention is a mower 10 which includes a frame 12, front wheel 14, and two side wheels 16. The wheels 14, 16 attach to the frame 12. Below frame 12 is a mower deck 18 which includes one or more blades (not shown) which are rotated by pulleys 19 and a drive mechanism (not shown).

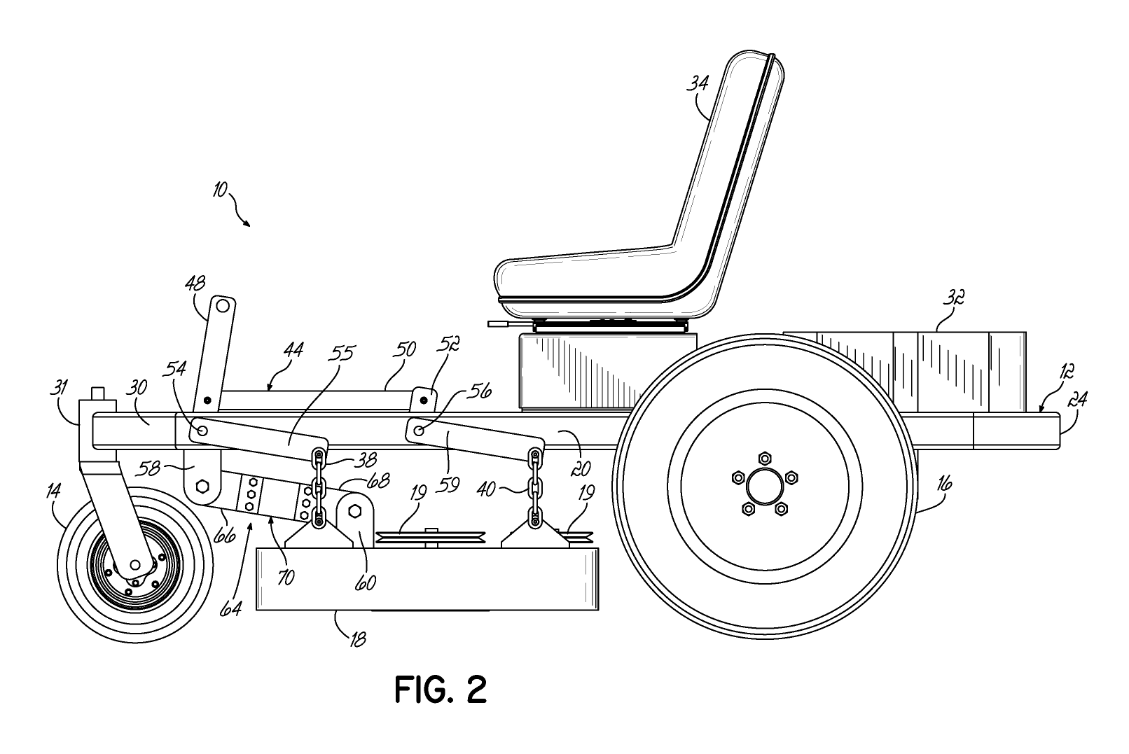

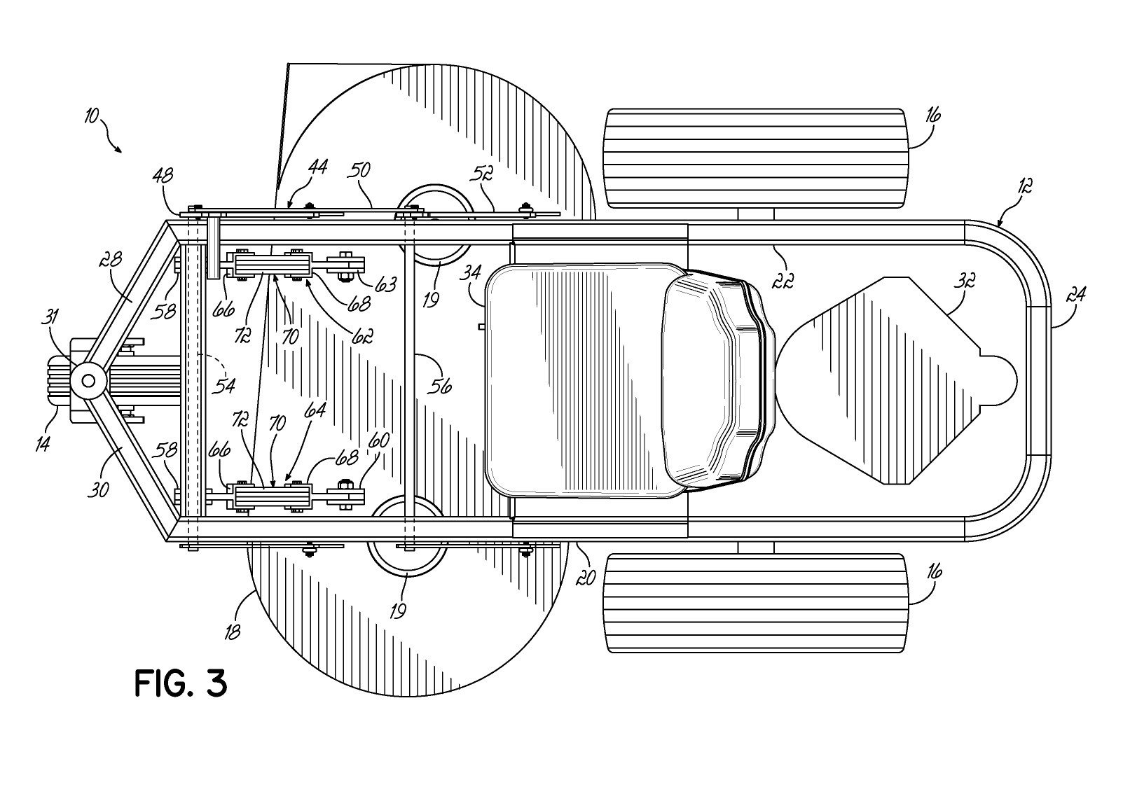

The particular design of the frame can vary widely. But, as shown, frame 12 of the mower shown in FIGS. 1-3 is formed from side frame bars 20 and 22 and rear frame bar 24. The frame 12 further includes a forward crossbar 26. Extended from sidebars 20 and 22, forward of crossbar 26, are forward-most frame bars 28 and 30. As shown, the front wheel attaches to a bearing 31 at the point where forward bar bars 28, 30 come together. The side wheels 16 are attached to side frame members 20 and 22, respectively.

An engine 32 is mounted on the rear portion of the frame 12 adjacent rear frame member 24. Forward of the engine is a seat 34. As shown, FIGS. 1-3 omit various common components typical of all riding mowers, such as the controls and the like, which form no part of the present invention.

The mower deck is supported by forward connectors 38, 39 and rearward connectors 40, 41 that allow for vertical movement of the deck relative to the frame. This support mechanism is exemplary and other support mechanisms typically used with riding mowers can be used. As shown, these four connectors are chains, but any connectors that allow for vertical movement and which are typically used to support a mower deck can be utilized in the present invention. The four connectors 38-41 attach to a support assembly 44.

Support assembly 44 includes “L” shaped control lever 48 and “L” shaped pivotal arm 52 which are fixed to forward and rear rods 54, 56. These rods extend through side frame bars 20, 22 and are fixed to pivoting arms 55, 59. Lever 48 and arms 52, 55 and 59 are attached to chains 38-41. A linkage 50 extends between lever 48 and “L” shaped pivoting arm 52. When lever 48 moves, it moves linkage 50 and “L” shaped arm 52.

Thus, as the control lever 48 is pushed forward, for example by the foot of the operator, it will cause the front rod 54 to rotate and link 52 to move, which causes arm 52 and rod 56 to rotate. The rotation of rods 54 and 57 will cause arms 55 and 59 to rotate, thus lifting or lowering deck 18.

In addition to the support assembly 44, the mower deck 18 is also fixed to crossbar 26 of frame 12, with first and second flexible brackets 62 and 64, which extend from frame flanges 58 attached to the crossbar 26 at one end and to mower deck flanges 60, 63 attached to the forward portion of the mower deck 18. Brackets 62 and 64 provide limited lateral flexibility and can have various designs which provide this limited flexibility. Because brackets 60, 62 are pivotally-attached to the frame and the mower deck brackets 60, 63 and the frame brackets 58, they do not prevent vertical movement of the mower deck

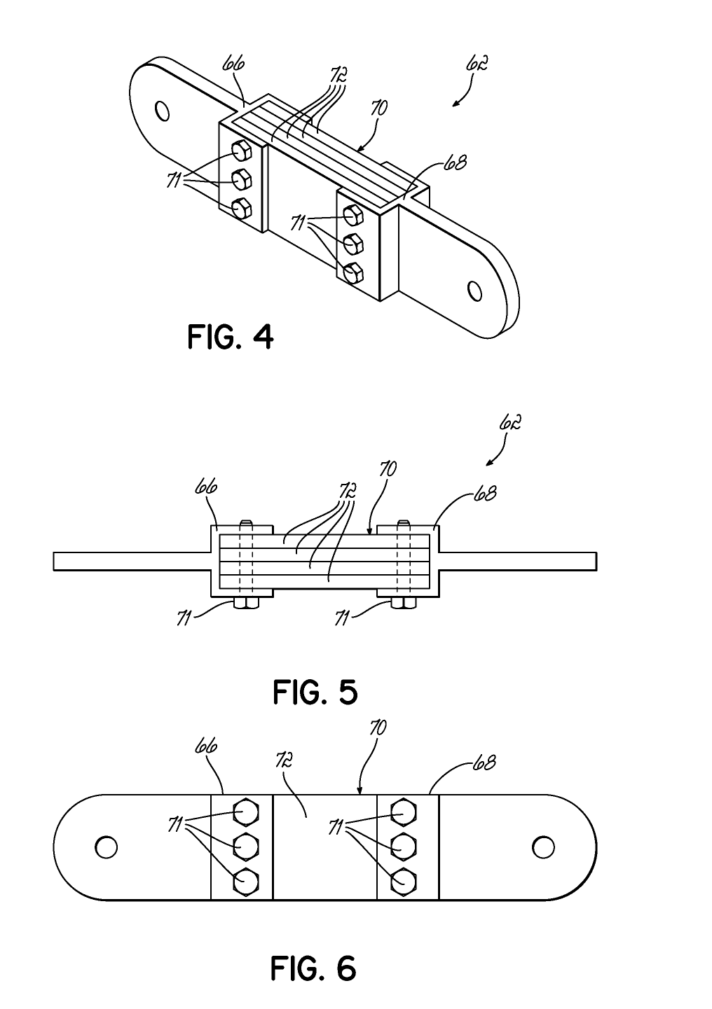

As shown, brackets 62, 64 are clevis brackets. Each of these clevis brackets 62 and 64 are identical and only bracket 62 is shown in FIGS. 4-6.

As shown in FIGS. 4, 5 and 6, each clevis bracket includes a first clevis 66 and a second clevis 68 connected together by a flexible rubber member 70. As shown, the rubber member 70 is attached to the respective clevises by fasteners 71. The flexible member 70 is typically a rubber member. It can be a solid piece of rubber or a plurality of rubber pads. Basically it must be designed so that there is minimal or no flexing or compression which allows forward or rearward movement of the mower deck relative to the frame, but which has a desired lateral flexibility. Flexible member 20 can be any natural or synthetic rubber which provides sufficient strength. Typically, the rubber member 70 will be formed from a plurality of coplanar rubber pads 72 (four shown). These rubber pads typically are fiber or mesh reinforced, which prevents compression but permits lateral flexing. The pads can be adhered together.

Further, the rubber pads 72 are sufficiently rigid so that during the general operation of the mower (i.e. when the mower deck is not hitting an object), the mower does not move laterally. However, they are sufficiently flexible so that, if a mower deck strikes an object, such as a fence post or the like, it will flex laterally from center at least 1, and optionally 2, 3, 4 or more inches to allow the deck to move around the fixed object without damaging the mower deck. In one example, the combined thickness of the pads is two inches, with a height of three inches, and length of six inches. The lateral flexibility is about 1.5 inches either direction from center. The dimensions of the flexible member may vary depending on the design, size and weight of the mower and mower deck, as well as the physical properties of the flexible member.

Due to the lateral flexibility of the brackets 60 and 62, the mower deck can be made from a thinner gauge metal. Because of this lateral movement, when a mower deck strikes a rock or fence post, it will move laterally, as opposed to absorbing all of the force from the impact, which can damage the deck.

As shown, the mower 10 has three wheels, although it can have four wheels. But a lighter weight mower deck (permitted by the use of the mounting brackets 60, 62), requires only one wheel to support the forward portion of the mower 10. Therefore, the mower is more maneuverable and allows one to get closer to a fixed object with the mower deck than would be possible with a mower with four wheels.

Accordingly, the present invention provides a mounting assembly for a mower deck which provides for limited lateral movement of the mower deck relative to the mower frame to thereby reduce damage to the mower deck when it strikes an immovable object. This allows the mower deck itself to be lighter, which allows the mower, in turn, to be designed with three wheels instead of four. This allows the mower to get closer to edges and objects.

This has been a description of the present invention, along with the preferred method of practicing the invention. However, the invention itself should only be defined by the appended claims, wherein I claim:

1. A self-propelled mower comprising:
a frame supported by a plurality of wheels;
a mower deck;
wherein said mower deck is attached to said frame and is movable vertically relative to said frame;
at least one bracket further connecting said mower deck to said frame;
wherein said bracket is laterally flexible, permitting said deck to shift laterally relative to said frame.

2. The mower claimed in claim 1 wherein said flexible bracket includes first and second rigid connectors joined by a flexible member and wherein said first rigid connector is pivotally attached to said mower deck and said second rigid connector is pivotally attached to said frame.

3. The mower claimed in claim 2 wherein said bracket has first and second clevises and first and second mounting plates attached to said clevises and wherein said flexible member extends between said first and second clevises, and wherein said first mounting plate attaches to said frame and said second mounting plate attaches to said mower deck.

4. The mower claimed in claim 3 wherein said flexible member is rubber.

5. The mower claimed in claim 4 wherein said flexible member comprises a plurality of coplanar rubber pads.

6. The mower claimed in claim 1 wherein said mower is a riding mower.

7. The mower claimed in claim 1 comprising at least two flexible brackets pivotally attached to said frame and said mower.

8. The mower claimed in claim 7 wherein said brackets are fixed to forward portions of said mower deck.

9. The mower claimed in claim 1 having two rear wheels and only one front wheel.

10. The mower claimed in claim 1 wherein said mower deck is attached to said frame by a plurality of chains.

11. The mower claimed in claim 7 wherein said flexible brackets prevent rearward movement of said mower deck relative to said frame.

12. The mower claimed in claim 11 wherein said flexible brackets allow the mower deck to move laterally at least 1.5 inches relative to said frame.
